(19) United States
(12) Patent Application Publication
(10) Pub. No.: US 2020/0055694 A1
(43) Pub. Date: Feb. 20, 2020

(54) Elevator-operating interface device, elevator system and methods of operation

(71) Applicant: Techmetics Solutions Pte. Ltd., Singapore (SG)

(72) Inventors: Maksim Sokolov, Singapore (SG); Mathan Muthupillai, Singapore (SG)

(21) Appl. No.: 15/999,214

(22) Filed: Aug. 16, 2018

(51) Int. Cl. B66B 1/34; B66B 1/28; B66B 1/52; B66B 5/00; B66B 9/00; B66B 1/46

(52) U.S. Cl. CPC B66B 1/3461; B66B 1/28; B66B 1/52; B66B 2201/4638; B66B 9/00; B66B 1/468; B66B 5/0018

(57) ABSTRACT

An elevator-operating interface device has circuitry adapted to receive commands over a wireless communications link, processing circuitry to process those commands, and actuator devices responsive to outputs of the processing circuitry to operate desired elevator control buttons.

### FIELD OF THE INVENTION

The present invention is in the field of transportation. Embodiments relate to elevator operation.

### BACKGROUND OF THE INVENTION

Increasingly operators of locations such as hotels are seeking to reduce costs by providing transport robots for transporting items like linen, food and drink or luggage to a guest's room, thereby avoiding the need to employ additional human staff. A similar situation may occur in hospitals where items such as linen, drugs or samples need to be transported. Where the premises has multiple floors the robot may use an elevator, for example a service elevator or a normal guest elevator to move between the floors. For example, when a guest checks in the guest's luggage may be loaded by staff onto a robot which then transports the luggage to the gust's room, and after being unloaded there returns to the check in reception area. Similarly, when a guest orders room service the food and/or drink may be loaded onto a robot at the kitchen floor and then the robot carries its load to the relevant guest room on a different floor, and returns once again to the kitchen floor or to some other location.

Where new premises are being built it is possible to have elevators installed that include means for integration into a robot/human environment ab initio. However, where existing premises are being converted for additionally using robots it is complex and expensive to modify the existing elevator controls to accommodate robots. Also it may only be possible to modify the existing elevators to accommodate a single type of robot. If different types of robots are to be used, this may be complicated and cost a lot.

It would be useful to address these issues of cost and complexity.

### SUMMARY OF THE INVENTION

In one aspect there is provided an elevator operating system in which a robot interacts with a control device installed in the elevator passenger compartment to enable the robot to actuate the floor buttons of the elevator car. The control device may be provided at the time of installation of the elevator system, or retro-fitted to an already-installed system. Significant cost savings are expected as, implementing the techniques disclosed herein, it is not necessary to tap into the existing elevator control system which is logistically complex and expensive, given the fact that elevator contractors inevitably charge high rates for their assistance in interfacing with the existing control system.

The interaction may be wireless.

In another aspect there is provided a wireless communication system by which a user waiting for an elevator can interact with an add-on control device installed in the elevator passenger compartment to enable the user to actuate the floor buttons of the elevator car.

The user may be a robot for example a luggage transport robot or a robot for delivering food and/or drink to a hotel room.

In yet another aspect there is disclosed a device for installation in an elevator car in association with user controls of the car, the device being adapted to operate the user controls of the car in response to signals received by the device over a wireless communications link.

The device may be adapted to sense the floor on which an associated elevator car is located, and to emit a signal over the link when a desired floor is reached.

In a further aspect there is disclosed an elevator system, the system having an elevator car and a robot, the elevator car being adapted to move between floors of a structure, the elevator car having a control panel disposed inside the car and having elevator floor buttons corresponding to the floors, wherein operation of a button causes the elevator car to move to the floor corresponding to the operated button, the elevator car further having a device disposed therein, the device adapted to receive commands over a wireless communications link and in response to a command to cause an actuator to engage the elevator floor button corresponding to the received command, and the robot having circuitry adapted to issue a command over the wireless communication link to the device thereby to call the elevator car to the floor where the robot is currently situated.

In this system the device may have circuitry for detecting that the elevator car has reached the floor where the robot is currently situated, the device being adapted to communicate with the robot to enable the robot to enter the elevator car.

In response to detection that the elevator car has reached the floor where the robot is currently situated, the device may issue a door hold command until the device determines that the robot is inside the elevator car.

When the robot has entered the car, the robot may communicate with the device to cause the device to actuate the floor button corresponding to the destination floor of the robot.

In a yet further aspect there is provided a method of calling an elevator car having providing a device disposed in an elevator car, the device adapted to receive commands over a wireless communications link and in response to those commands to causes one of plural actuators to operate a corresponding elevator floor button.

In a still further aspect there is provided an interface device having circuitry adapted to receive commands over a wireless communications link, processing circuitry to process those commands, and actuator devices responsive to output circuitry of the processing circuitry to operate desired elevator control buttons.

The elevator control buttons may include floor buttons.

The elevator control buttons may include a door hold button.

The actuator devices may be servo actuators, solenoid actuators or similar.

The interface device may include a communications interface module such as a GSM modem for receiving command signals and for providing input signals related thereto to the processing circuitry as said commands.

The interface device may have sensing circuitry adapted to determine whether elevator doors are open or closed.

The interface device may have transmitting circuitry responsive to door open signals to transmit information to a device outside the elevator car to indicate to the device that entry into the elevator car is possible.

The interface device may have a housing with user-operable means adapted to enable a user to select a desired destination floor, the user operable means being adapted to provide actuation signals to actuator devices corresponding to the desired destination floor.

The user operable means may be connected to provide inputs to the processing circuitry whereby the actuators are actuated.

A method of the invention can be used to operate an elevator system that includes the steps of: (a) providing an interface device having circuitry adapted to receive commands over a wireless communications link, processing circuitry to process those commands, and actuator devices responsive to outputs of the processing circuitry to operate desired elevator control buttons; and (b) securing the interface device to an elevator car to operate the control buttons of the elevator car.

Another method of the invention can include the elevator car being a pre-existing elevator car.

Another method of the invention can include the step of (c) responding to commands received by the interface device over the wireless communications by causing at least one of the actuator devices to operate a corresponding elevator floor button of the elevator control buttons.

Another method of the invention can include the step of (d) calling the elevator car to a floor that corresponds to an elevator floor button of the elevator control buttons.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 shows a partial block schematic drawing of an elevator system.

FIG. 2 is a flow chart describing the operation of an exemplary embodiment.

FIG. 3 is a flow chart describing the operation of an exemplary embodiment.

FIG. 4 is a flow chart describing the operation of an exemplary embodiment.

### DETAILED DESCRIPTION OF AN EMBODIMENT

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

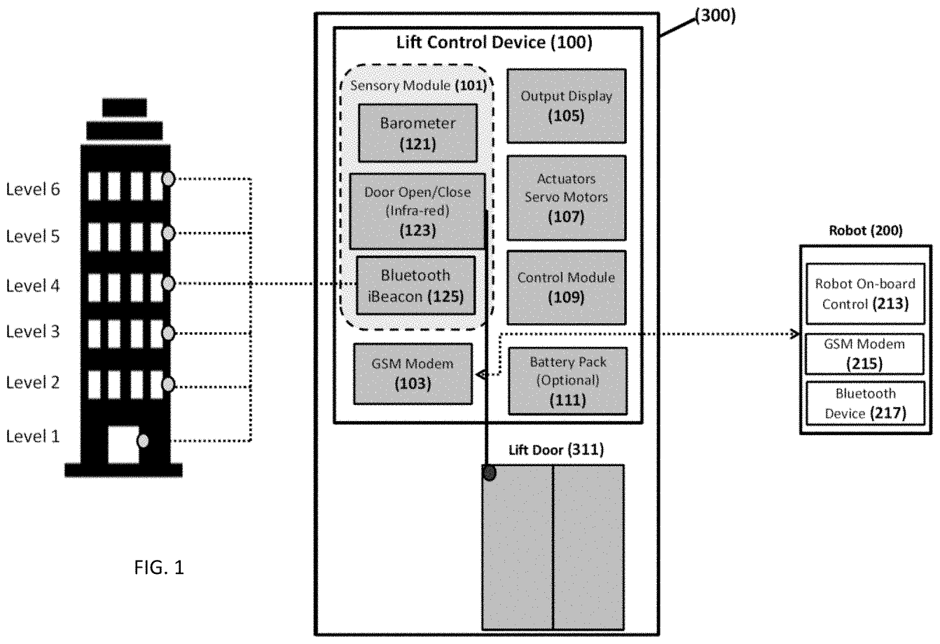

Referring to FIG. 1, an elevator installation 1 is shown in the context of a six story building 13, for example a hotel or hospital. The building is serviced by an elevator 300. As is conventional, the elevator car is fitted with user operable buttons or similar controls, referred to hereinafter as elevator operating buttons. The buttons typically are arranged in a matrix and include floor buttons, an emergency alarm button, a “hold elevator-door open” button, a door close button. The car may in some cases also have a card slot into which an identification card, for example the door key of a room, is inserted to allow the elevator to go to one or more selected floors or levels.

The floor buttons, when selected, act upon the overall elevator control system to direct the car to the floor corresponding to one or more selected buttons. The emergency alarm button sounds an alarm, perhaps locally, perhaps at a remote monitoring location or maybe both.

In accordance with embodiments a control device 100 is secured in association with the elevator operating buttons of an elevator car, for example disposed in an overlaying relationship with the elevator operating buttons. Typically, it will be mechanically secured over the car floor buttons and other buttons, and has actuators (not shown) arranged to engage with those buttons.

Control Device Structure.

An embodiment of the control device 100 has sensory circuitry 101, wireless communication circuitry, in this embodiment a GSM modem 103, an output display 105, plural actuators 107, processing circuitry 109 and a battery 111.

The sensory circuitry 101 includes: a barometer 121, a door open-close sensor 123 and optionally a Bluetooth iBeacon 125.

The barometer 121 is provided to sense air pressure at different levels to sense which level the elevator car is currently at.

The door open/close sensor 123, in this case an infrared sensor, is operable to sense the elevator door status to gauge if a robot can enter/exit the elevator.

A Bluetooth iBeacon 125 may be provided as an addition fail-safe mechanism to determine the floor which the elevator car is currently at. In such a case the beacon system utilizes Low Energy Bluetooth Beacons at each elevator landing to ascertain when a floor of concern to the robot is reached.

The GSM Modem 103 provides communication between the robot and the remainder of the elevator control device 100. It will be understood that wireless communication links other than GSM may be used.

The embodiment described also has:

Output Display 105 providing feedback and key information to a user;

Actuators 107 to provide trigger/pressing action on to the elevator buttons;

A control module 109, affording CPU command communications for the process flow;

A battery pack 111 used to power the elevator control device independently.

In most embodiments elevator buttons are provided on a housing of the control device 100 for the passengers to press the level and control the elevator car.

The control device may also have a card access module to enable robots to go to any restricted levels for which access control is in place. An admin card may be provided as part of the control device and it will be trigged electronically when the robot needs to use the elevator to access restricted floors.

Robot Interface

An embodiment of a robot interface will now be described.

In an embodiment the robot 200 itself is an arbitrary robot to which is added supplementary circuitry fitted on the robot to communicate with the elevator device.

The embodiment of the interface includes wireless communication circuitry 215 for transmitting commands to the elevator car control device 100, and for receiving signals and commands from the control device. The interface further has robot onboard control circuitry 213, operable to provide signals from the wireless communications link, for example signals that indicate the elevator car door is fully open, that robot may proceed into the elevator car, and processing/control circuitry 217.

There may be a Bluetooth communicator to communicate with elevator control device 100 via Bluetooth to send commands.

Elevator System

In the described embodiment there is a single elevator 300 serving a hotel. The elevator 300 has an installed add-on control device 100 providing an interface with pre-existing floor buttons and other control buttons, such as a “hold door open” button.

The control device 100 includes wireless communication circuitry 103 for receiving call and other commands from a mobile device such as a transport or other robot 200.

In one embodiment, for simplicity of description, there is a single robot 200 and a single elevator. In other families of embodiments, there is an overall robot control center operating plural robots. There may be plural elevators, and those elevators may be under control of an elevator control system, with each elevator having user-operable control buttons.

It will be understood that many different arrangements could be envisaged, with different number of robots and differing numbers of elevator cars.

Continuing with the presently described embodiment, when a robot 200 requires the car and the robot is at a starting floor, for example level 1, for example the reception floor, or the kitchen floor, the robot 200 calls the elevator car 300 to that starting floor. For the sake of clarity, the term “starting floor” is used herein to represent any floor where the robot 200 is located outside the elevator car 300 and to which floor the robot is calling the car 300, or is about to call the car. It does this by issuing a request to the control device 100 in the car using wireless communication to the wireless communication circuitry 103 of the control device 100.

In one family of embodiments the robot 200 issues, as the request, a task command that includes data indicative of the starting floor, where the robot is located, together with data indicative of the destination floor, and these two items are stored by the control device 100. This is not however essential to the invention, and embodiments where only data indicative of the starting floor is output as the request are envisaged.

The control device 100 of the elevator car 300 responds by causing its actuators to operate the floor button 303 specific to the starting floor and in the simplest case of operation the car comes to the starting floor, where the robot 200 is currently located outside the elevator car 300. Where the floor buttons are push buttons the actuators may be for example solenoids moved electrically to actuate the corresponding button. Where the floor buttons are capacitively operated, capacitive actuators are used instead. The nature of the actuators is not fundamental to the general concept.

In a more general case, the elevator car 300 will at this point either be moving or will be stationary, and at some time after this the car 300 will move to a floor, and open its doors. This floor may or may not be the starting floor where the robot 200 is currently located.

As noted above the control device 100 has a barometer 121 that allows the control device 100 to determine the direction of movement of the car 300 and also to determine at what height the car is currently at.

Upon arriving at a floor and opening the doors the control device 100 checks what floor it is at by using one or both of the barometer 121 and a floor identification device, such as an iBeacon.

Alternatively, other identification devices could be used.

The car doors 311 open at each called floor during the journey of the car, and the control device 100 ascertains whether or not each current floor is the starting floor, based upon the signals from the barometer and/or the floor identification device and a comparison with the stored starting floor value.

If the current floor does not correspond to the starting floor value, the control device 100 again causes the button corresponding to the starting floor to be operated.

When the car door 311 opens at the robot's starting floor, the door open-close sensor 123 indicates to the control device 100 that the door has opened and the control device 100 actuates the actuator of the “hold door open” button. The control device 100 then notifies elevator status to the robot 200 to enter the elevator car 300 via the wireless communications link and the onboard control circuitry 213.

Some robots will have the ability to determine if the elevator is already full to prevent the robot from entering, and the robot may then release the elevator. Other arrangements are also envisaged so this is not essential to the invention.

Where a control center is included a robot encountering a full elevator may report that fact to the control center, and the control center may release the elevator.

Once the robot 200 has entered the elevator it emits a signal to the control device 100 to cause the “hold door open” button to become released.

In some embodiments, the robot's on board control system automatically emits a signal to the control device when it is in the car, to allow the “hold open” to be removed? In some embodiments, the robot reports to the control center which communicates with the control device 100.

Then the robot 200 issues its destination command to the elevator car 300 via the control device 100 and over the wireless communications link. The control device 100 stores the destination.

The elevator car 300 then moves either in the correct direction for the needs of the robot 200 or in the opposite direction if it has a pre-existing call to a floor in the opposite direction.

When the elevator car 300 moves to a new floor (right or wrong direction) the control device 100 is programmed to ascertain whether or not that current floor is the floor to which the robot 200 wishes to go based upon the signals from the barometer 121 and/or the floor identification device 125 and the stored destination floor.

At each incorrect floor—i.e. a floor not corresponding to the stored destination—the control device 100 causes the destination floor button to be operated.

If the signals indicate the desired destination floor has been reached, the control device 100 actuates the actuator of the “hold door open” button. The control device 100 then notifies elevator status to the robot 200 indicating that it can leave the elevator car 300. Once the robot 200 has left the elevator it emits a wireless signal to the control device 100 and in response to that signal the control device releases the “hold door open” button to allow the doors 311 to close and the elevator then proceeds as normal.

In some embodiments once the robot 300 successfully finishes task «go outside elevator», it communicates directly to the control device 100 to allow the elevator to proceed as required. In embodiments where there is a control center, the control center may send signal to elevator device release Hold Door button and then, proceed next task step (Release elevator).

Flowcharts

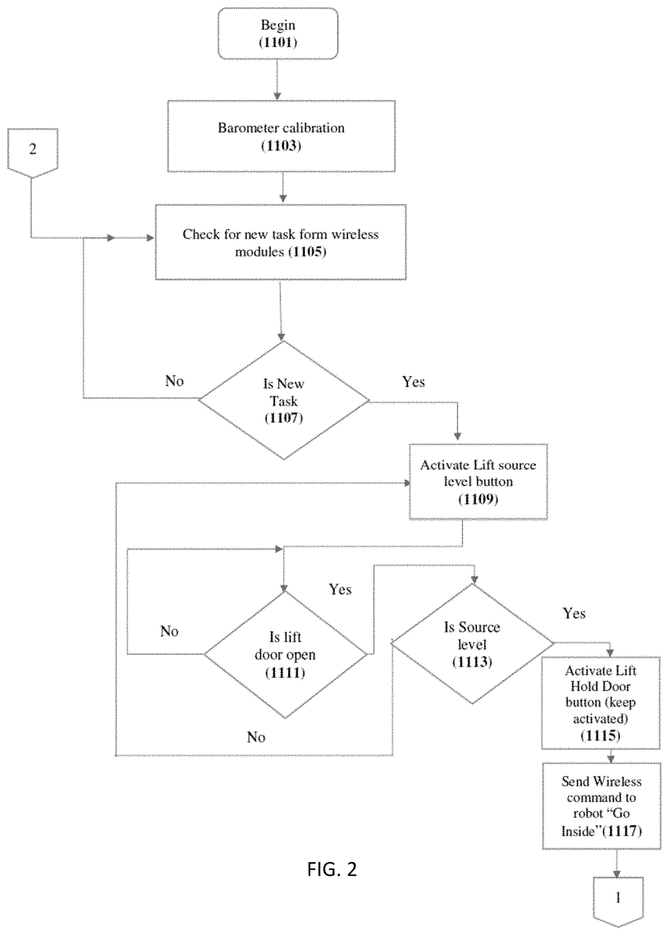

Referring to FIG. 2, the start of operations is at 1101, after which the control process proceeds to step 1103 where the barometer 121 is calibrated. Process then moves to step 1105 where a check is made of inputs from the wireless communication unit 103. At this point a decision step 1107 is entered to determine whether a new task has been received over the wireless communication link. If the answer is no, the process loops. If a new task HAS been received the control process proceeds to step 1109 where the correct button for the robot's starting floor is operated. Elevator movement then occurs, as discussed above, and the process proceeds to step 1111 which determines whether the elevator door is open, in response to inputs from the door sensor 123. While the door remains closed the process loops.

Once it is detected that the door is open the decision step 1111 passes the process on to step 1113, where the control device 100 compares the floor the elevator is at, as determined by the barometer 121 and/or the beacon 125, with the floor value stored when the robot's starting floor was input.

If the answer is “no”, then the process reverts to step 1109 where the starting floor button is again actuated.

If the answer is “yes”, the process moves to step 1115 which causes the control device 100 to operate the “elevator hold/doors open” button. This prevents the elevator car from moving, and holds open the doors of the car. Process then moves to step 1117 in which the control device outputs via the wireless communications link 103 a signal for the robot 200 to indicate “enter elevator car.”

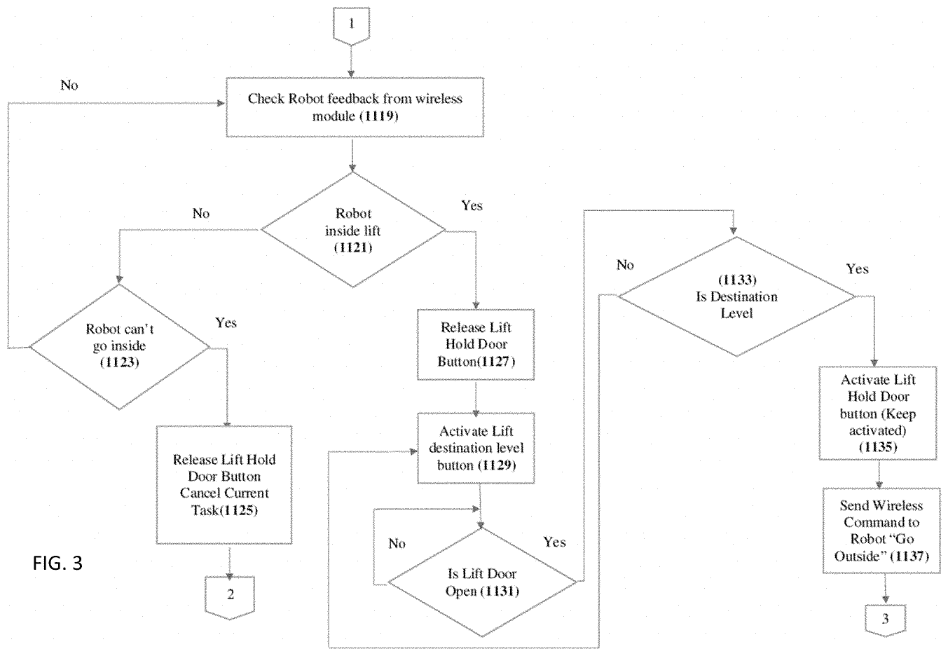

Referring to FIG. 3, the process moves on from step 1117 to step 1119 which checks information received from the robot 200 to see what has happened to it. The process goes to a decision step 1121 where a determination is made whether or not the robot 200 is inside the car. If the answer is “no” then the process moves to decision step 1123 which decides if the robot CANNOT enter the car 300.

From step 1123, if the answer is “no” (i.e. the robot 200 CAN enter the car 300) the process resumes at step 1119 and loops. If at step 1123 the answer is “yes” (i.e. the robot 200 cannot enter the elevator car 300) then the process goes to step 1125 where the “elevator hold/doors open” button is released, and the task is cancelled. This “cannot enter” is typically as a result of the robots own sensing system detecting an obstacle that cannot be avoided.

Returning to step 1121, if it is found the robot 200 has entered the car 300, process proceeds to step 1127 where the “elevator hold/doors open” button is released and process then proceeds to step 1129. At this step, the control device 100 acts upon the floor button corresponding to the destination desired by the robot 200, and control passes to step 1131 which is a decision step determining if the car doors 311 are open. If not the process loops around step 1131. If “yes” then the control device determines at step 1133 based upon stored destination information whether the car has reached the destination or not.

If the answer is “no” then the process reverts to step 1129, and the destination button is again actuated.

If the answer is “yes” then at step 1135 the “elevator hold/doors open” button is engaged and at step 1137, the control device 100 sends a “go out” command to the robot 200 over the wireless link.

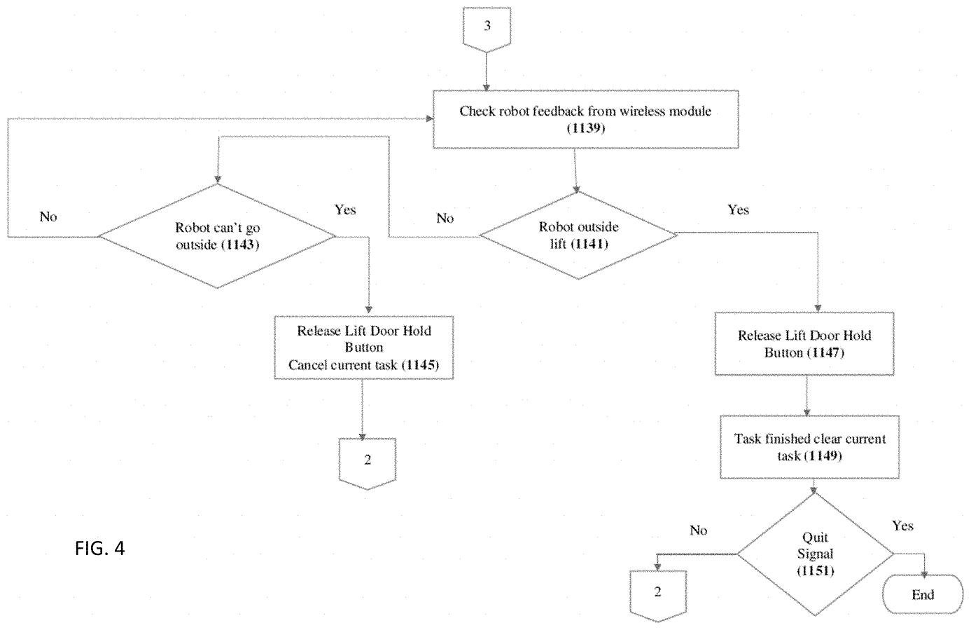

Referring now to FIG. 4, after step 1137, control passes to step 1139 in which inputs are received to determine where the robot 200 is. In one embodiment of a robot, the robot has a map, a navigation system and sensors. The decision step 1141 has a “no” result indicating the robot 200 has not left the car 300, and if this is true then the process proceeds to step 1143 where a decision is made whether the robot 200 cannot go out of the car 300.

If it is not true that the robot cannot leave the car step 1143 leads back to step 1139. If it is true the robot 200 cannot leave the car 300 the “elevator hold/doors open” button is released and the task is cancelled, leaving the robot inside the car 300 (step 1145). This determination is typically as a result of the robot's own sensing system. This process step then leads in to step 1105, see FIG. 2.

If it is decided the robot 200 has left the car 300, the “elevator hold/doors open” button is released (step 1147) and the process proceeds to step 1149, task finished, clear task. If a quit signal is received (step 1151) the process ends. If not the process proceeds with step 1105 (FIG. 2).

The above-described flowchart is only an example of process flows that could be used, and many other could be used.

A family of embodiments has now been described in the context of robots. The control device 100 may of course respond to devices other than robots if they have the correct identification information for the control device of concern. For example, a wheelchair user or a person of restricted mobility may use their phone to call an elevator using the device, and set a destination floor.

In the described embodiments (above) some tasks have been described as assigned to the robot—for example detecting an obstacle. The invention is not however restricted to this and other means of detecting may be provided, for example as part of the control device 100.

The above description specifically mentions hotels and hospitals. It is of course clear that embodiments may be used in other premises, for example industrial assembly buildings where items need to be transported to different floors, laboratories and other scientific locations. The invention is not restricted to any application.

An embodiment has been described. It will be clear to a person of skill in the art that many different modifications could be made while still following the teaching of this application. The invention is not to be taken as restricted to the specific details described above. Other aspects, advantages, and modifications are within the scope of the following claims.

What is claimed is:

1. An elevator-operating interface device comprising circuitry adapted to receive commands over a wireless communications link, processing circuitry to process those commands, and actuator devices responsive to outputs of the processing circuitry to operate desired elevator control buttons.

2. The interface device according to claim 1, wherein the elevator control buttons comprise floor buttons.

3. The interface device according to claim 2, wherein the elevator control buttons comprise a door hold button.

4. The interface device according to claim 1, wherein the actuator devices are servo actuators.

5. The interface device according to claim 1, further comprising a GSM modem for receiving command signals and for providing input signals related thereto to the processing circuitry as said commands.

6. The interface device according to claim 1, comprising sensing circuitry adapted to determine whether elevator doors are open or closed.

7. The interface device according to claim 1, further comprising transmitting circuitry responsive to door open signals to transmit information to a device disposed outside the elevator car to indicate to the device that entry into the elevator car is possible.

8. The interface device according to claim 1, comprising a housing with user-operable means adapted to enable a user to select a desired destination floor, the user operable means being adapted to provide actuation signals to actuator devices corresponding to the desired destination floor.

9. An elevator system, the system comprising an elevator car and a robot, the elevator car being adapted to move between floors of a structure, the elevator car comprising a control panel disposed inside the car and comprising elevator floor buttons corresponding to the floors, wherein operation of a button causes the elevator car to move to the floor corresponding to the operated button, the elevator car further comprising a device disposed therein, and secured with respect to the elevator floor buttons so as to be able to operate them in response to command signals.

10. The elevator system according to claim 9, wherein the device is adapted to receive commands over a wireless communications link and in response to a command to cause an actuator to engage the elevator floor button corresponding to the received command, and the robot comprising circuitry adapted to issue a command over the wireless communication link to the device thereby to call the elevator car to the floor where the robot is currently situated.

11. The elevator system according to claim 10, comprising circuitry for detecting that the elevator car has reached the floor where the robot is currently situated, the device being adapted to communicate with the robot to enable the robot to enter the elevator car.

12. The elevator system according to claim 10, wherein in response to detection that the elevator car has reached the floor where the robot is currently situated, the device is adapted to issue a door hold command until the device determines that the robot is inside the elevator car.

13. The elevator system according to claim 11, wherein when the robot has entered the car, the robot is adapted to communicate with the device to cause the device to actuate the floor button corresponding to the destination floor of the robot.

14. A method of operating an elevator system comprising the steps of:
(a) providing an interface device comprising circuitry adapted to receive commands over a wireless communications link, processing circuitry to process those commands, and actuator devices responsive to outputs of the processing circuitry to operate desired elevator control buttons; and
(b) securing the interface device to an elevator car to operate the control buttons of the elevator car.

15. The method of claim 14, wherein the elevator car comprises a pre-existing elevator car.

16. The method of claim 14, further comprising the step of:
(c) responding to commands received by the interface device over the wireless communications by causing at least one of the actuator devices to operate a corresponding elevator floor button of the elevator control buttons.

17. The method of claim 14, further comprising the step of:
(d) calling the elevator car to a floor that corresponds to an elevator floor button of the elevator control buttons.
